(19) United States
(12) Patent Application Publication
(10) Pub. No.: US 2024/0289671 A1
(43) Pub. Date: Aug. 29, 2024

(54) METHOD FOR PROCESSING QUBITS, QUANTUM CIRCUIT AND NON-TRANSITORY COMPUTER READABLE MEDIUM

(71) Applicant: Alibaba Damo (Hangzhou) Technology Co., Ltd., Hangzhou, Zhejiang (CN)

(72) Inventors: Tenghui WANG, Hangzhou, Zhejiang (CN); Chunqing DENG, Hangzhou, Zhejiang (CN)

(21) Appl. No.: 18/508,872

(22) Filed: Nov. 14, 2023

(30) Foreign Application Priority Data
Nov. 16, 2022 (CN) 202211460047.7

(51) Int. Cl. G06N 10/40

(52) U.S. Cl. CPC G06N 10/40

(57) ABSTRACT

A method for processing qubits, includes: controlling a high excited energy level of qubits to resonate with a target resonant cavity, the high excited energy level being an energy level greater than or equal to a second excited energy level; and applying a microwave to the qubits in a process of continuous resonance between the high excited energy level of the qubits and the target resonant cavity to control a first excited energy level of the qubits to adiabatically evolve towards a dissipative energy level of the target resonant cavity to initialize the qubits.

### CROSS-REFERENCE TO RELATED APPLICATIONS

The disclosure claims the benefits of priority to Chinese Application No. 202211460047.7, filed on Nov. 16, 2022, which is incorporated herein by reference in its entirety.

### TECHNICAL FIELD

The present disclosure relates to the technical field of quantum, and in particular to a method for processing qubits, a quantum circuit and a non-transitory computer readable medium.

### BACKGROUND

Unlike traditional classical physical quantities low level and high level representing 0 and 1, the field of quantum computing uses physical quantities (such as electron spinning and light polarization) as 0 state and 1 state of qubits. Without any operation, ideal qubits should be 100% in the 0 state, but due to the temperature still being on the order of tens of mK, it will cause a small amount of thermal excitation and still have partial residual qubits in the 1 state. The partial residual qubits will bring about an error in the initial state, leading to greater inaccuracy in subsequent calculation.

Generally, the commonly used method for initializing qubits is to use direct microwave drive, that is, microwaves are directly applied to the qubits to initialize the qubits. However, the initialization time required by the above method is too long and the microwave power required is high, therefore, the initialization efficiency is low.

### SUMMARY OF THE DISCLOSURE

Embodiments of the present disclosure provide a method for processing qubits. The method includes: controlling a high excited energy level of qubits to resonate with a target resonant cavity, the high excited energy level being an energy level greater than or equal to a second excited energy level; and applying a microwave to the qubits in a process of continuous resonance between the high excited energy level of the qubits and the target resonant cavity to control a first excited energy level of the qubits to adiabatically evolve towards a dissipative energy level of the target resonant cavity to initialize the qubits.

Embodiments of the present disclosure provide a quantum circuit. The quantum circuit includes a target resonant cavity; and qubits coupled to the target resonant cavity and coupled to a read line through the target resonant cavity, the qubits being initialized qubits, wherein the qubits are initialized by: controlling a high excited energy level of qubits to resonate with a target resonant cavity, the high excited energy level being an energy level greater than or equal to a second excited energy level; and applying a microwave to the qubits in a process of continuous resonance between the high excited energy level of the qubits and the target resonant cavity to control a first excited energy level of the qubits to adiabatically evolve towards a dissipative energy level of the target resonant cavity to initialize the qubits.

Embodiments of the present disclosure provide a non-transitory computer readable medium that stores a set of instructions that is executable by one or more processors of an apparatus to cause the apparatus to perform operations including: controlling a high excited energy level of qubits to resonate with a target resonant cavity, the high excited energy level being an energy level greater than or equal to a second excited energy level; and applying a microwave to the qubits in a process of continuous resonance between the high excited energy level of the qubits and the target resonant cavity to control a first excited energy level of the qubits to adiabatically evolve towards a dissipative energy level of the target resonant cavity to initialize the qubits.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1 illustrates a hardware structural block diagram of a computer terminal for implementing a method for processing qubits, according to some embodiments of the present disclosure.

FIG. 2 illustrates a flowchart of an exemplary method for processing qubits, according to some embodiments of the present disclosure.

FIG. 3 illustrates a schematic diagram of an exemplary quantum circuit, according to some embodiments of the present disclosure.

FIG. 4 illustrates a schematic diagram of an example quantum chip, according to some embodiments of the present disclosure.

FIG. 5 illustrates a schematic diagram of an example quantum memory, according to some embodiments of the present disclosure.

FIG. 6 illustrates a schematic diagram of an example quantum computer, according to some embodiments of the present disclosure.

FIG. 7 illustrates a schematic diagram of energy levels of qubits and a read resonant cavity during coupling, according to some embodiments of the present disclosure.

FIG. 8 illustrates a flowchart of an exemplary method for processing qubits, according to some embodiments of the present disclosure.

FIG. 9 illustrates a schematic diagram when a second excited energy level of qubits resonates with a read resonant cavity, according to some embodiments of the present disclosure.

FIG. 10 illustrates a schematic diagram of energy level splitting that occurs on the spectrum of qubits when a second excited energy level of qubits resonates with a read resonant cavity, according to some embodiments of the present disclosure.

FIG. 11 illustrates a schematic diagram of microwaves applied to qubits, according to some embodiments of the present disclosure.

FIG. 12 illustrates a schematic diagram of a waveform of magnetic flux pulses applied to qubits before qubits reach a resonance point, according to some embodiments of the present disclosure.

FIG. 13 illustrates a structural block diagram of an exemplary apparatus for processing qubits, according to some embodiments of the present disclosure.

FIG. 14 illustrates a structural block diagram of an exemplary computer terminal, according to some embodiments of the present disclosure.

### DETAILED DESCRIPTION

Reference can now be made in detail to example embodiments, examples of which are illustrated in the accompanying drawings. The following description refers to the accompanying drawings in which the same numbers in different drawings represent the same or similar elements unless otherwise represented. The implementations set forth in the following description of example embodiments do not represent all implementations consistent with the disclosure. Instead, they are merely examples of apparatuses and methods consistent with aspects related to the disclosure as recited in the appended claims. Particular aspects of present disclosure are described in greater detail below. The terms and definitions provided herein control, if in conflict with terms or definitions incorporated by reference.

According to some embodiments, the present disclosure provides a method for processing qubits. It should be noted that the steps illustrated in the flowchart in the drawings may be executed in a computer system such as a set of computer-executable instructions. In addition, although a logic order is illustrated in the flowchart, in some cases, the steps illustrated or described may be executed in a different order than here.

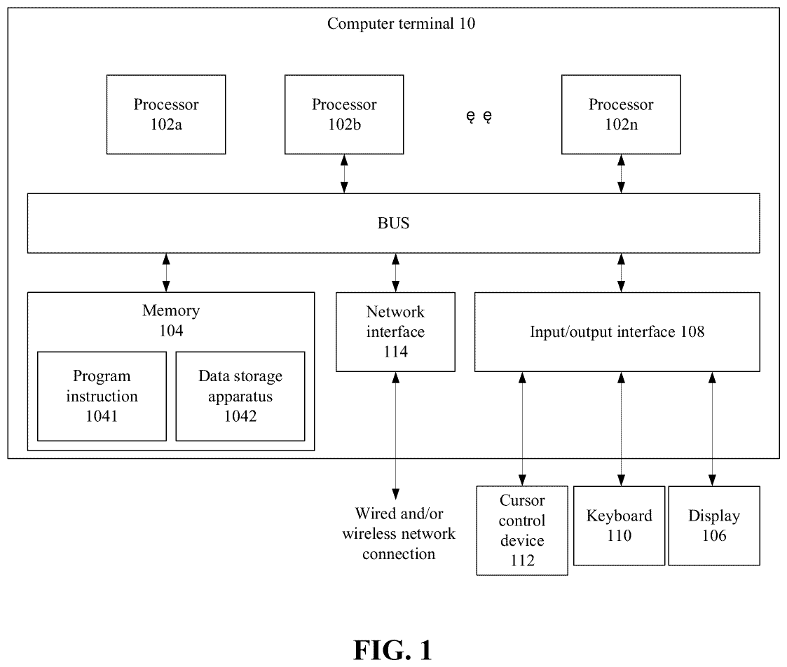

The methods provided by the present disclosure may be executed on a mobile terminal, a computer terminal, or a similar computing apparatus. FIG. 1 illustrates a hardware structural block diagram of an exemplary computer terminal 10 (or mobile device) for implementing a method for processing qubits, according to some embodiments of the present disclosure. As shown in FIG. 1, computer terminal 10 (or mobile device) may include one or more processors (illustrated as 102a, 102b, . . . , 102n, including, but not limited to, processing apparatuses such as micro processing units MCU or programmable logic devices FPGA), a memory 104 for storing data, and a transmission apparatus for communication functions. In addition, computer terminal 10 further includes: a display 106, an input/output interface (I/O interface) 108, a universal serial bus (USB) port (which may be included as one of ports of a bus), a keyboard 110, a cursor control device 112, a network interface 114, a power supply, or a camera. It is appreciated that the structure illustrated in FIG. 1 is only schematic and does not limit the structure of the electronic apparatus described above. For example, computer terminal 10 may further include more or fewer components than those illustrated in FIG. 1, or has a configuration different from that illustrated in FIG. 1.

It should be noted that the one or more processors or other data processing circuits described above may often be referred to as “data processing circuits” herein. The data processing circuit can be fully or partially embodied as software, hardware, firmware, or any other combination. In addition, the data processing circuit may be a single independent processing module, or fully or partially integrated into any of the other components in computer terminal 10 (or mobile device). As mentioned in this embodiment of this application, the data processing circuit serves as a processor control (such as selecting a varistor terminal path connected to an interface).

Memory 104 may be configured to store software programs and modules of application software, such as program instructions 1041 or data storage apparatuses 1042 corresponding to the method for processing qubits provided by the present disclosure. One or more processors (e.g., processor 102a, 102b, 102n) execute various functional applications and data processing by running the software programs and modules stored in memory 104, thus implementing qubit process methods of the application programs described above. Memory 104 may include high-speed random memories, and may also include non-volatile memories, such as one or more magnetic storage apparatuses, flash memories, or other non-volatile solid-state memories. In some embodiments, memory 104 may further include memories remotely disposed relative to the processor, and the remote memories may be connected to computer terminal 10 through a network. Examples of the network include, but are not limited to, the Internet, an intranet, a local area network, a mobile communication network, and a combination thereof.

The transmission apparatus 16 is configured to receive or transmit data through a network. The specific examples of the network may include a wireless network provided by a communication provider of computer terminal 10. In an example, the transmission apparatus includes a Network Interface Controller (NIC), which may be connected to other network devices through a base station to communicate with the Internet. In an example, the transmission apparatus may be a Radio Frequency (RF) module, which is configured to communicate with the Internet in a wireless manner.

Display 106 can be, for example, a touch screen Liquid Crystal Display (LCD) that enables the user to interact with the user interface of computer terminal 10 (or mobile device).

It should be noted here that in some embodiments, computer device 10 (or mobile device) illustrated in FIG. 1 may include hardware components (including circuits), software components (including computer codes stored on computer-readable media), or a combination of hardware component and software component. It should be pointed out that FIG. 1 is only an example of a specific example and aims to illustrate the types of components that may exist in the computer device (or mobile device).

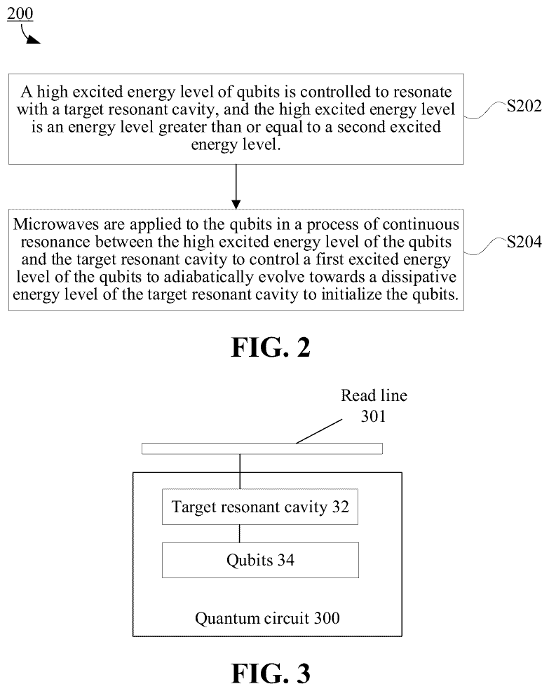

In the above operating environment, the present disclosure provides a method for processing qubits illustrated in FIG. 2. FIG. 2 illustrates a flowchart of an exemplary method 200 for processing qubits, according to some embodiments of the present disclosure. As shown in FIG. 2, method 200 includes steps S202 and S204.

At step S202, a high excited energy level of qubits is controlled to resonate with a target resonant cavity. The high excited energy level is an energy level greater than or equal to a second excited energy level.

In some embodiments, the execution subject of the method for processing qubits may be a terminal or a server. The terminal may be various types of terminals, such as computer terminals, mobile terminals, virtual terminals, etc. However, regardless of which type of terminal, it is necessary to have a certain level of computing power that meets the computing need. The server may also be in various forms. For example, it may be a single computer device, a cluster of computers including multiple computers, a local computing unit, or a remote cloud server.

In some embodiments, the type of the qubits may be various. For example, the qubits may be Fluxonium qubits, Transmon qubits, charge qubits, phase qubits, and other types of frequency-adjustable qubits, which is not limited in the present disclosure.

In some embodiments, the qubits are Fluxonium qubits. Fluxonium is a type of superconducting qubit, which is composed of a Josephson junction in parallel with an inductor and capacitor. In this composition, there is a large inductor (generally prepared from a large number of Josephson junctions (e.g., 100) arrays or high dynamic inductance materials). The electric energy EC corresponding to the capacitance, the inductive energy EL corresponding to the inductor, and the Josephson energy EJ are close to each other (about an order of magnitude). Due to the large frequency adjustment range of Fluxonium, it is relatively easy to achieve coupling of a second excited state or higher excited state of the qubits to the target resonant cavity. The large nonlinearity ensures that the second excited energy level or higher excited energy level of the qubits is coupled to the target resonant cavity without affecting the qubits.

In some embodiments, the type of the target resonant cavity may be various. For example, in regard to whether it is related to the qubits, the target resonant cavity may a read resonant cavity coupled to the qubits, and the read resonant cavity is configured to read a quantum state of the qubits. The target resonant cavity may also be configured to solely initialize the qubits, which will not be described through examples one by one.

In some embodiments, when the target resonant cavity described above is a read resonant cavity for reading the qubits, the coupling between the qubits and the read resonant cavity is a weak coupling, that is, the read resonant cavity should minimize the influence on the qubits as much as possible to avoid causing an error in the reading result of the qubits. In the methods provided by the present disclosure, initialization of the qubits can be quickly achieved through the energy levels inherent in the qubits, that is, the initialization of the qubits can be achieved under the situation of weak coupling between the qubits and the read resonant cavity. A qubit initialization means that qubit state is reset, so that qubits are in a ground state or a first excited state before calculation begins. Different states correspond to different energy levels.

In some embodiments, the high excited energy level described above is an energy level greater than or equal to the second excited energy level. In some embodiments, the high excited energy level is relative to a ground level and a first excited energy level of the qubits. For example, it can be a third excited energy level, a fourth excited energy level, or a higher excited energy level.

In some embodiments, when the high excited energy level of the qubits is controlled to resonate with the target resonant cavity, various methods may be used. For example, a method of controlling the qubits or a method of controlling the target resonant cavity may be adopted, which will be respectively described below.

In some embodiments, the high excited energy level of the qubits may be controlled to resonate with the target resonant cavity by: acquiring a first relationship between a frequency of the high excited energy level of the qubits and a magnetic flux applied to the qubits; acquiring a first target frequency of the target resonant cavity; and controlling the high excited energy level of the qubits to resonate with the target resonant cavity by adjusting the magnetic flux applied to the qubits based on the first relationship and the first target frequency.

When the first relationship between the frequency of the high excited energy level of the qubits and the magnetic flux applied to the qubits is acquired, a frequency of the qubits may be measured by applying multiple different magnetic fluxes to the qubits to obtain measurement results. Based on the multiple different magnetic fluxes and the corresponding measured frequencies of the magnetic fluxes, the relationship (i.e., the first relationship described above) between the magnetic flux and the frequency of the qubits can be simulated. Various simulation methods may be adopted. For example, simulation may be performed by adopting a method based on predetermined mathematical modeling. For example, based on a mathematical foundation, a model that includes qubit parameter constraints is established. Based on the measurement data obtained from the above measurement, model evolution is adopted to obtain the first relationship between the frequency and the magnetic flux of the qubits. When the first target frequency of the target resonant cavity is acquired, a frequency reader (such as another read resonant cavity) may be adopted to directly read it, or other parameters of the target resonant cavity may be measured, and then the frequency (i.e., the first target frequency) of the target resonant cavity may be calculated based on these other parameters. When the high excited energy level of the qubits is controlled to resonate with the target resonant cavity by adjusting the magnetic flux applied to the qubits based on the first relationship and the first target frequency, a target magnetic flux corresponding to the first target frequency is determined based on the first relationship. Then the magnetic flux added to the qubits is enabled to reach the target magnetic flux by slowly adjusting the magnetic flux applied to the qubits, that is, by gradually increasing the magnetic flux applied to the qubits, so that the high excited energy level of the qubits resonates with the target resonant cavity.

In some embodiments, the high excited energy level of the qubits may also be controlled to resonate with the target resonant cavity by: acquiring a second relationship between the frequency of the target resonant cavity and a magnetic flux applied to the target resonant cavity; acquiring a second target frequency of the high excited energy level of the qubits; and controlling the high excited energy level of the qubits to resonate with the target resonant cavity by adjusting the magnetic flux applied to the target resonant cavity based on the second relationship and the second target frequency.

Similar to the method of acquiring the first relationship between the frequency of the high excited energy level of the qubits and the magnetic flux applied to the qubits described above, the second relationship between the frequency of the target resonant cavity and the magnetic flux applied to the target resonant cavity can also be obtained by performing measurement first and performing simulation. When the second target frequency of the high excited energy level of the qubits is acquired, a method similar to the method of acquiring the first target frequency of the target resonant cavity described above may be adopted, that is, it may be obtained by direct measurement or calculation based on other parameters of the target resonant cavity. When the high excited energy level of the qubits is controlled to resonate with the target resonant cavity by adjusting the magnetic flux applied to the target resonant cavity based on the second relationship and the second target frequency, a magnetic flux corresponding to the second target frequency may be determined based on the second relationship, and the magnetic flux applied to the target resonant cavity is slowly increased to the corresponding magnetic flux, so that the high excited energy level of the qubits resonates with the target resonant cavity.

In some embodiments, controlling the high excited energy level of the qubits to resonate with the target resonant cavity includes: controlling the high excited energy level of the qubits and the target resonant cavity to adiabatically reach a resonance point by adjusting the magnetic flux applied to the qubits or the magnetic flux applied to the target resonant cavity.

It should be noted that the above methods, whether by adjusting the magnetic flux applied to the qubits or the magnetic flux applied to the target resonant cavity to enable the high excited energy level of the qubits and the target resonant cavity to reach the resonance point, are all achieved by an adiabatic means. An adiabatic means is an evolution means that keeps the system in an instantaneous eigenstate and has strong robustness.

At step S204, microwaves are applied to the qubits in a process of continuous resonance between the high excited energy level of the qubits and the target resonant cavity to control a first excited energy level of the qubits to adiabatically evolve towards a dissipative energy level of the target resonant cavity to initialize the qubits. In a three-energy-level system in which two independent energy levels are respectively coupled to an auxiliary energy level, adiabatic state transfer between the two independent energy levels is achieved by means of the auxiliary energy level, which refers to Stimulated Raman adiabatic passage.

In some embodiments, the microwaves applied to the qubits are low-power microwaves for transitioning from the first excited energy level to the second excited energy level or higher excited energy level of the qubits. Compared to the microwaves directly applied to the qubits to excite a bit excited state to the coupled dissipative resonant cavity, the power of low-power microwaves is low and it is easy to implement.

In some embodiments, the adiabatic evolution described above describes a process of a slow evolution of the instantaneous eigenstate of the system from the first excited state to an excited state of the resonant cavity under the regulation of the microwaves.

In some embodiments, microwaves may be applied to the qubits in the process of continuous resonance between the high excited energy level of the qubits and the target resonant cavity to control the first excited energy level of the qubits to adiabatically evolve towards the dissipative energy level of the target resonant cavity by: determining a target microwave, and microwave intensity of the target microwave increasing over time within a predetermined time period; and applying the target microwave to the qubits in the process of continuous resonance between the high excited energy level of the qubits and the target resonant cavity to control the first excited energy level of the qubits to adiabatically evolve towards the dissipative energy level of the target resonant cavity. By determining the target microwave that meet certain conditions, the accuracy of qubit initialization can be effectively improved.

In some embodiments, the target microwave described above may be in various forms, as long as the first excited energy level of the qubits can achieve adiabatic evolution towards the dissipative energy level of the target resonant cavity by the target microwaves. For example, determining the target microwaves may include: determining a microwave combination that continuously includes a first microwave band, a second microwave band, a third microwave band, and a fourth microwave band as the target microwave. An increase rate of the microwave intensity of the first microwave band over time is a first increase rate, an increase rate of the microwave intensity of the second microwave band over time is a second increase rate. The first increase rate is greater than the second increase rate, and the second increase rate approaches zero. An microwave intensity of the third microwave band decreases over time, and the fourth microwave band is in a microwave-free stage. When the target microwave is described by a relationship curve between the microwave intensity and time, the first microwave band may be a slowly ramp-up curve, the second microwave band is the corresponding microwave band that holds for a period of time after the first microwave band reaches a predetermined height, the third microwave band is a rapidly ramp-down curve, and there is no microwave in the fourth microwave band, that is, the microwave intensity of the fourth microwave band is zero. It should be noted that the target microwave corresponding to the combination of the four microwave bands described above is only one example, and the present disclosure is not limited thereto.

Through the above step, the microwaves are applied to the qubits in the process of continuous resonance between the high excited energy level of the qubits and the target resonant cavity to control the first excited energy level of the qubits to adiabatically evolve towards the dissipative energy level of the target resonant cavity to initialize the qubits. By adopting the above methods, when the modulated qubits resonate with the target resonant cavity, microwaves are applied to qubits to cause the first excited energy level of the qubits to transition to a high excited energy level, that is, the energy of the first excited energy level is transferred to a higher energy level, and the higher energy level in turn resonates with the target resonant cavity, so that the energy of the first excited energy level can continuously be transferred to the target resonant cavity and then is dissipated to the environment via the target resonant cavity, thus achieving the initialization of the qubits. Using modulated microwaves to directly excite the first excited energy level of the qubits to the resonant cavity not only eliminates the need for long-term initialization, but also eliminates the need for high-power microwaves, thus quickly achieving the initialization of the qubits. Moreover, the required microwave power is low, thus effectively improving the initialization efficiency of qubits.

FIG. 3 illustrates a schematic diagram of an exemplary quantum circuit 300, according to some embodiments of the present disclosure. As shown in FIG. 3, quantum circuit 300 includes: a target resonant cavity 32 and qubits 34. Target resonant cavity 32 can be a read resonant cavity. Qubits 34 are coupled to a read line 301 through target resonant cavity 32. Target resonant cavity 32 is coupled to qubits 34. Qubits 34 are initialized qubits. The initialization of the qubits are achieved by following steps: controlling a high excited energy level of qubits 34 to resonate with target resonant cavity 32, the high excited energy level being an energy level greater than or equal to a second excited energy level; and applying microwaves to qubits 34 in a process of continuous resonance between the high excited energy level of qubits 34 and target resonant cavity 32 to control a first excited energy level of qubits 34 to adiabatically evolve towards a dissipative energy level of target resonant cavity 32 to initialize qubits 34.

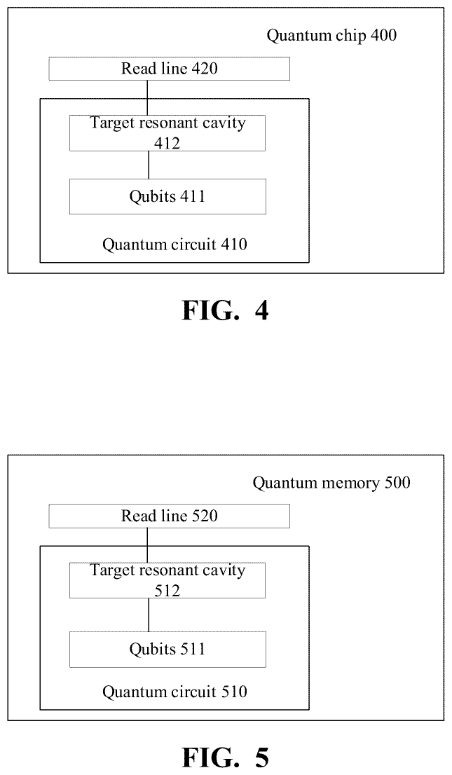

Some embodiments of the present disclosure further provide a quantum chip, which includes the quantum circuit described above. FIG. 4 illustrates a schematic diagram of an example quantum chip 400, according to some embodiments of the present disclosure. As shown in FIG. 4, quantum chip 400 includes a quantum circuit 410 which includes qubits 411 coupled to a target resonant cavity 412. Quantum circuit 410 is coupled to a read line 420. Specifically, qubits 410 are coupled to a read line 420 through target resonant cavity 412.

Some embodiments of the present disclosure further provide a quantum memory, which includes the quantum circuit described above. FIG. 5 illustrates a schematic diagram of an example quantum memory 500, according to some embodiments of the present disclosure. As shown in FIG. 5, quantum memory 500 includes a quantum circuit 510 which includes qubits 511 coupled to a target resonant cavity 512. Quantum circuit 510 is coupled to a read line 520. Specifically, qubits 510 are coupled to a read line 520 through target resonant cavity 512.

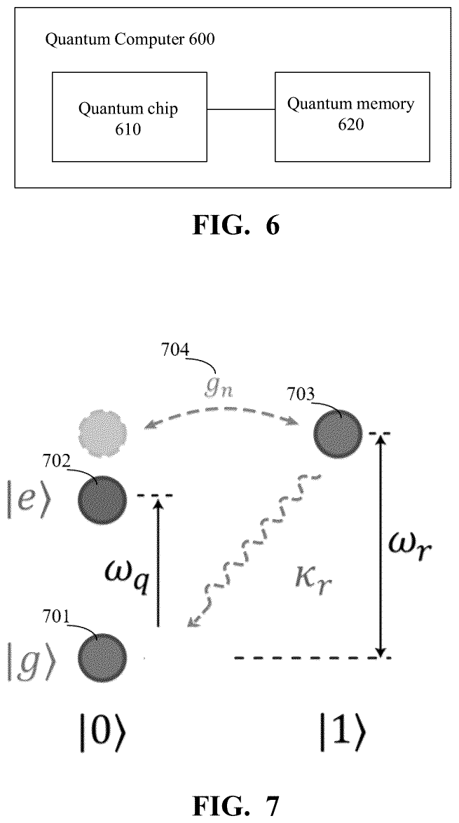

Some embodiments of the present disclosure further provide a quantum computer, which includes: a quantum chip and a quantum memory. The quantum chip or the quantum memory includes the quantum circuit described above. FIG. 6 illustrates a schematic diagram of an example quantum computer 600, according to some embodiments of the present disclosure. As shown in FIG. 6, quantum computer 600 includes a quantum chip 610 and a quantum memory 620. Quantum chip 610 may be quantum chip 400 as described in FIG. 4, and quantum memory 620 may be quantum memory 500 as described in FIG. 5.

Based on the embodiments above, exemplary implementations are provided.

The working frequency of the qubits is usually very low and will be maintained at a thermally stable state with a significant population of 1 state. Before the qubits work, it is necessary to initialize them and cool the system as much as possible to 0 state. When the qubits are initialized, the usual approach is to use microwaves to excite the 1 state of the qubits into a dissipative system. In a superconducting quantum system, such a dissipative system is typically a read resonant cavity for qubits. For example, as a new type of qubits, Fluxonium has the advantages of long decoherence time and large nonlinearity, making it one of the strong competitors for achieving large-scale quantum computing in the future. Its working frequency is usually very low and will be maintained at a thermally stable state with a significant population of 1 state. For large-scale Fluxonium chips, it is necessary to initialize the chips to facilitate the subsequent parameter calibration process.

Generally, direct microwave drive is adopted to excite bits into the read resonant cavity. This scheme requires long initialization time and requires high microwave power, making it difficult to expand. In addition, a frequency modulation scheme may also be adopted to achieve coupling between the resonant cavity and the bits. However, this scheme is limited by the frequency adjustable range of Fluxonium and its related parameter range, which is difficult to implement. Therefore, direct microwave drive is generally selected. However, due to the significant difference in frequency between qubits and the read resonant cavity, the equivalent coupling between them is very weak. Therefore, it is necessary to use microwaves lasting long and having high power to achieve such a state transfer process.

To achieve fast and high-accuracy initialization, in this implementation, it is proposed to complete the entire initialization process by enabling the high energy level of the qubits to resonate with the read resonant cavity, and applying the microwaves to transferring the energy of the qubits to the high energy level. In an actual operation process, the first excited state of the qubits, the high energy level of the qubits, and the read resonant cavity form a three-energy-level subsystem. By utilizing the stimulated Raman adiabatic passage, strong coupling between the qubit system and the read cavity system can be achieved without exciting the high energy level of the qubits, thus completing the initialization of the qubits.

The exemplary implementations provided in the present disclosure will be described below.

Before the implementation of the present disclosure is described, a system composed of qubits and a read resonant cavity through coupling will be described as below.

FIG. 7 illustrates a schematic diagram of energy levels of qubits and a read resonant cavity during coupling, according to some embodiments of the present disclosure. As shown in FIG. 7, |g>, |e>, and |0>, |1> are adopted to respectively represent a ground state and a first excited state of the qubits and the read resonant cavity. According to this identification, ball 701, ball 702, and ball 703 respectively represent that the system (composed of the qubits and the read resonant cavity) are in |g0>, |e0>, and |g1> states.

When the system is in |e0> (e.g., ball 702) and the bits need to be reset to |g>, parameter modulation may be performed on frequency-adjustable qubits, and then the qubits undergo interaction gn 704 with the rapidly decaying read resonant cavity, which achieves the exchange between |e0> (e.g., ball 702) and |g1> (e.g., ball 703) in terms of effect. After this exchange, the qubits are initialized to the ground state. The excitation of the read resonant cavity may be quickly dissipated through strong coupling with the external environment, and finally the system is stabilized to |g0> (e.g., ball 701).

Based on the above description, |g0>, |e0>, and |g1> (e.g., balls 701, 702, and 703) describe the state of the system composed of the qubits and the read resonant cavity. Generally, during description, it is necessary to involve the qubits and the read resonant cavity. However, for the sake of simplicity, when the states involved include the ground level of the quantum state or the 1 state of the read resonant cavity, the quantum state or the state of the read resonant cavity will be ignored during description. For example, for the above |g1> (e.g., ball 703), it may be directly described as the first level energy state of the read resonant cavity, since the qubits are in the ground state, which is ignored. In some embodiments, |f0> may be directly described as the second excited energy level state of the qubits, and |e0> may be directly described as the first excited energy level state of the qubits, more details of which will be described below.

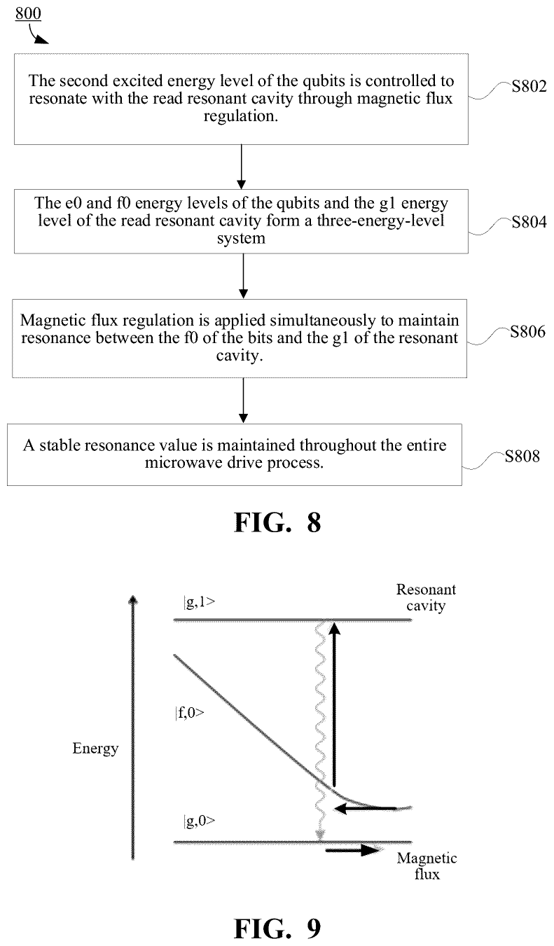

In this implementation, description is made by taking that the high excited energy level is the second excited energy level and the target resonant cavity is the read resonant cavity coupled to the qubits as an example. FIG. 8 illustrates a flowchart of an exemplary method 800 for processing qubits, according to some embodiments of the present disclosure. Method 800 includes step S802 to step S808.

At step S802, the second excited energy level of the qubits is controlled to resonate with the read resonant cavity through magnetic flux regulation.

In this step, the magnetic flux regulation used above may be either for the qubits or for the read resonant cavity. Regardless of the method used, it is acceptable to simply modulate the second excited state of the qubits to a state that resonates with the read resonant cavity. In this example, description is made by taking magnetic flux regulation for the qubits as an example.

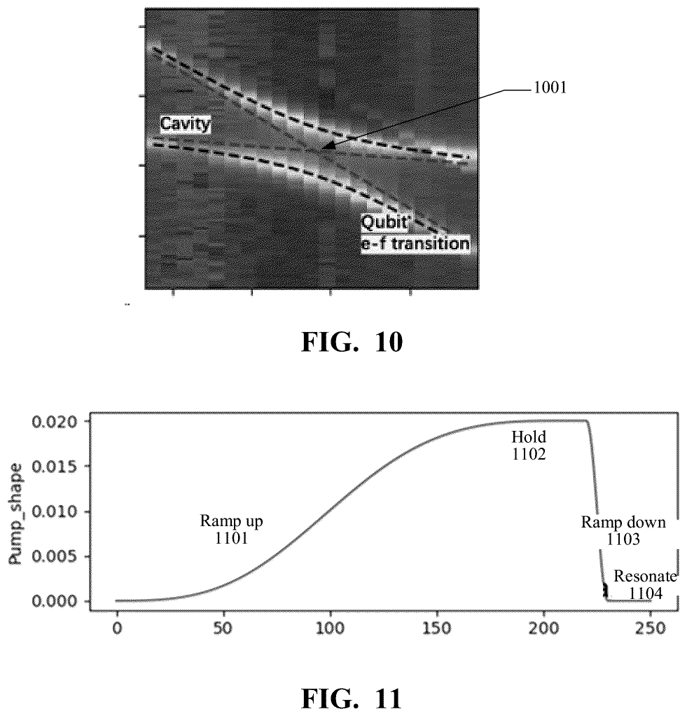

FIG. 9 illustrates a schematic diagram when a second excited energy level (e.g., |f0>) of qubits resonates with a read resonant cavity, according to some embodiments of the present disclosure. In FIG. 9, |f0> represents a second excited state of fluxonium and |g0> represents a ground state of fluxonium. As shown in FIG. 9, by applying magnetic flux regulation to the qubits, the second excited energy level of the qubits (corresponding to the second excited state |f0> in FIG. 9) resonates with the read resonant cavity (specifically the energy level |g1> of the read resonant cavity). That is, the energy of the second excited state |f0> of the qubits is modulated to resonate with the energy level |g1> of the read resonant cavity through magnetic flux regulation. At this time, we can observe an energy level splitting coupled to the read resonant cavity in the spectrum of |e> to |f> transition, where |e> represents a first excited state and |f> represents a second excited state. An energy level splitting refers to two energy levels with the same energy split due to energy level repulsion in the presence of coupling. FIG. 10 illustrates a schematic diagram of energy level splitting that occurs on the spectrum of qubits when a second excited energy level of qubits resonates with a read resonant cavity, according to some embodiments of the present disclosure. As shown in FIG. 10, an intersection 1001 of dashed lines is defined as a required amplitude for magnetic flux modulation. Qubit e-f transition represents a transition between a first excited energy level of qubits and a second excited energy level of qubits.

Referring back to FIG. 8, at step S804, the e0 and f0 energy levels of the qubits and the g1 energy level of the read resonant cavity form a three-energy-level system.

$$H = \frac{1}{2} [ \begin{matrix}0 & {Ω}_{e f} ( t ) & 0 \\ {Ω}_{e f} ( t ) & Δ ( t ) & g \\ 0 & g & 0\end{matrix} ] \begin{matrix}\begin{matrix}\vert e 0 〉 \\ \vert f 0 〉\end{matrix} \\ \vert g 1 〉\end{matrix}$$

At this time, a microwave drive may be applied between |e0> and |f0>, and the drive is labeled as Ω_{ef}(t). The function of magnetic flux modulated frequency is labeled as Δ(t). Usually, during resonance, Δ(t) is set to 0, and the required magnetic flux intensity may be determined in the previous step.

At step S806, in the final implementation process, magnetic flux regulation is applied simultaneously to maintain resonance between the f0 of the bits and the g1 of the resonant cavity. On this basis, the intensity of Ω_{ef} is slowly increased to achieve adiabatic evolution from e0 to g1. It should be noted that the waveform of the microwaves applied is not limited as long as the adiabatic evolution conditions are met. FIG. 11 illustrates a schematic diagram of microwaves applied to qubits, according to some embodiments of the present disclosure. As shown in FIG. 11, the microwave range of the microwaves may be divided into four bands. A first band 1101 is a ramp-up stage that the microwave intensity rises slowly. A second band 1102 is a hold stage that the microwave intensity is held. A third band 1103 is a ramp-down stage that the microwave intensity is rapidly weakened. A fourth band 1104 is a stage that resonating microwave-free drive is held for a certain period of time.

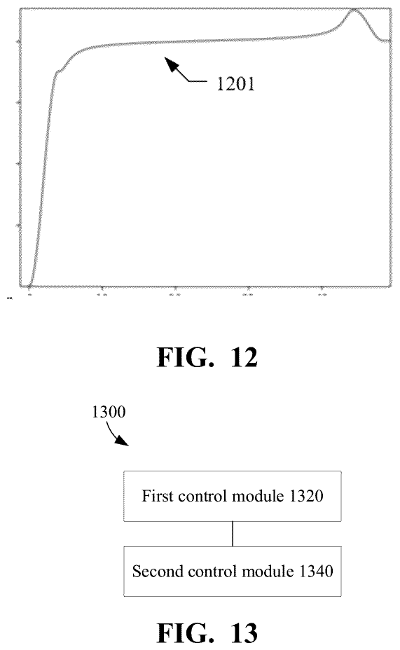

Referring back to FIG. 8, at step S808, for magnetic flux modulation, a stable resonance value is maintained throughout the entire microwave drive process described above. But before applying microwave drive, it is necessary to slowly change the qubits from the working DC bias point to the resonance point in advance. FIG. 12 illustrates a schematic diagram of a waveform of magnetic flux pulses applied to qubits before qubits reach a resonance point, according to some embodiments of the present disclosure. As shown in FIG. 12, a reference waveform 1201 that changes slowly is given. Under the application of the magnetic flux pulses with this reference waveform, the qubits slowly reach the resonance point. In the process of applying the magnetic flux pulses with the reference waveform described above, the qubits can adiabatically reach the resonance point from the normal working point, and the population at higher energy levels can be removed.

The above exemplary implementations can be used for initialization of Fluxonium bits. By coupling the auxiliary energy level to the bit system and the dissipative system respectively, efficient qubit initialization can be achieved in a larger parameter space under a smaller microwave drive, thus achieving high-accuracy initialization of Fluxonium bits.

It should be noted that in this implementation, other bit energy levels, such as the third excited state or higher excited state, may be selected to replace the second excited state. Other dissipative channels may also be selected to replace the resonant cavity, and the microwaves may be applied from a read line.

In this implementation, since the drive can be applied through the energy levels between the bit systems, the equivalent coupling is very strong. Therefore, the required microwave drive time and intensity are shorter and weaker compared to the general initialization scheme. In addition, the entire process is adiabatic evolution and has great robustness to changes in parameters. In actual simulation, good initialization results can be achieved within large microwave drive intensity, drive frequency, and magnetic flux ranges.

Therefore, this scheme utilizes the high energy level of bits as an aid, which can enhance the equivalent coupling between the bit computing space and the read resonant cavity, and accelerate the initialization speed. The entire process utilizes the adiabatic evolution process within the three energy levels, the range of available initialization parameters is wide, and the robustness is good.

It should be noted that for each of the foregoing method embodiments, for ease of description, the method embodiment is described as a series of action combinations, but a person of ordinary skill in the art should learn that the present disclosure is not limited to an order of described actions, because according to the present disclosure, some steps may be performed in other orders or at the same time. Further, a person of ordinary skill in the art should also understood that the embodiments described in the description are all exemplary embodiments, and the actions and modules involved may not necessarily be necessary for the present disclosure.

According to the descriptions in the foregoing implementations, a person of ordinary skill in the art may clearly learn that the method according to the foregoing embodiment may be implemented by relying on software and a necessary universal hardware platform, and of course, hardware can also be used. However, in many cases, the former is the better implementation method. Based on such an understanding, the technical solutions of the present disclosure essentially, or the part contributing to the existing technology, may be presented in the form of a software product. The computer software product is stored in a computer-readable storage medium (for example, an ROM/RAM, a magnetic disk, or an optical disk) including several instructions to enable a terminal device (which may be a mobile phone, a computer, a server, a network device, or the like) to perform the methods described in the embodiments of the present disclosure.

Some embodiments of the present disclosure further provide an apparatus for implementing the method for processing qubits. FIG. 13 illustrates a structural block diagram of an apparatus 1300 for processing qubits, according to some embodiments of the present disclosure. As shown in FIG. 13, apparatus 1300 includes: a first control module 1320 and a second control module 1340. Apparatus 1300 will be described below.

First control module 1320 is configured to control a high excited energy level of qubits to resonate with a target resonant cavity. The high excited energy level is an energy level greater than or equal to a second excited energy level. Second control module 1340 is connected to first control module 1320 and configured to apply microwaves to the qubits in a process of continuous resonance between the high excited energy level of the qubits and the target resonant cavity to control a first excited energy level of the qubits to adiabatically evolve towards a dissipative energy level of the target resonant cavity to initialize the qubits.

It should be noted here that first control module 1320 and second control module 1340 described above correspond to step S202 and step S204 in method 200 shown in FIG. 2. The examples and application scenarios implemented by the modules are the same as those implemented by the corresponding steps, but are not limited to the content disclosed in the present disclosure. It should be noted that the modules can run as part of the apparatus in computer terminal 10 shown in FIG. 1.

Some embodiments of the present disclosure provide a computer terminal. The computer terminal may be any computer terminal device in a computer terminal group. In some embodiments, the computer terminal may also be replaced with a terminal device such as a mobile terminal.

In some embodiments, the computer terminal may be located on at least one network device of multiple network devices in a computer network.

In this embodiment, the computer terminal can execute a program code for the following steps in a method for processing qubits of an application program: controlling a high excited energy level of qubits to resonate with a target resonant cavity, and the high excited energy level being an energy level greater than or equal to a second excited energy level; and applying microwaves to the qubits in a process of continuous resonance between the high excited energy level of the qubits and the target resonant cavity to control a first excited energy level of the qubits to adiabatically evolve towards a dissipative energy level of the target resonant cavity to initialize the qubits.

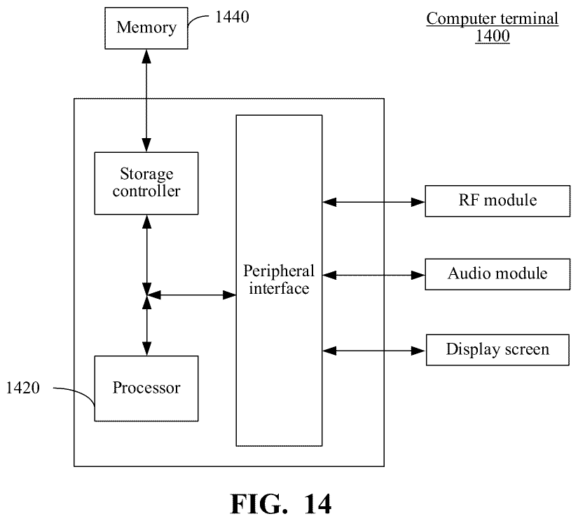

In some embodiments, FIG. 14 illustrates a structural block diagram of an exemplary computer terminal 1400, according to some embodiments of the present disclosure. As shown in FIG. 14, computer terminal 1400 may include: one or more (only one is illustrated in figure) processors 1420, a memory 1440, etc.

Memory 1440 may be configured to store software programs and modules, such as program instructions/modules corresponding to the method and apparatus for processing qubits in the embodiments of the present disclosure. Processor 1420 executes various functional applications and data processing by running the software programs and modules stored in memory 1440, thus implementing the method for processing the qubits described above. Memory 1440 may include high-speed random memories, and may also include non-volatile memories, such as one or more magnetic storage apparatuses, flash memories, or other non-volatile solid-state memories. In some embodiments, memory 1440 may further include memories remotely disposed relative to the processor, and the remote memories may be connected to the computer terminal through a network. Examples of the network include, but are not limited to, the Internet, an intranet, a local area network, a mobile communication network, and a combination thereof.

Processor 1420 can call the information stored in memory 1440 and application programs through a transmission apparatus to execute the following steps: controlling a high excited energy level of qubits to resonate with a target resonant cavity, and the high excited energy level being an energy level greater than or equal to a second excited energy level; and applying microwaves to the qubits in a process of continuous resonance between the high excited energy level of the qubits and the target resonant cavity to control a first excited energy level of the qubits to adiabatically evolve towards a dissipative energy level of the target resonant cavity to initialize the qubits.

In some embodiments, processor 1420 can also execute a program code for the following steps: acquiring a first relationship between a frequency of the high excited energy level of the qubits and a magnetic flux applied to the qubits; acquiring a first target frequency of the target resonant cavity; and controlling the high excited energy level of the qubits to resonate with the target resonant cavity by adjusting the magnetic flux applied to the qubits based on the first relationship and the first target frequency.

In some embodiments, processor 1420 can also execute a program code for the following steps: acquiring a second relationship between a frequency of the target resonant cavity and a magnetic flux applied to the target resonant cavity; acquiring a second target frequency of the high excited energy level of the qubits; and controlling the high excited energy level of the qubits to resonate with the target resonant cavity by adjusting the magnetic flux applied to the target resonant cavity based on the second relationship and the second target frequency.

In some embodiments, processor 1420 can also execute a program code for the following steps: controlling the high excited energy level of the qubits and the target resonant cavity to adiabatically reach a resonance point by adjusting the magnetic flux applied to the qubits or the magnetic flux applied to the target resonant cavity.

In some embodiments, processor 1420 can also execute a program code for the following steps: determining target microwaves, and microwave intensity of the target microwaves increasing over time within a predetermined time period; and applying the target microwaves to the qubits in the process of continuous resonance between the high excited energy level of the qubits and the target resonant cavity to control the first excited energy level of the qubits to adiabatically evolve towards the dissipative energy level of the target resonant cavity.

In some embodiments, processor 1420 can also execute a program code for the following steps: determining a microwave combination that continuously includes a first microwave band, a second microwave band, a third microwave band, and a fourth microwave band as the target microwaves. An increase rate of the microwave intensity of the first microwave band over time is a first increase rate, the increase rate of the microwave intensity of the second microwave band over time is a second increase rate, and the first increase rate is greater than the second increase rate.

In some embodiments, processor 1420 can also execute a program code, wherein the second increase rate approaches zero, the microwave intensity of the third microwave band decreases over time, and the fourth microwave band is in a microwave-free stage.

In some embodiments, processor 1420 can also execute a program code, wherein the target resonant cavity is a read resonant cavity coupled to the qubits, and the read resonant cavity is configured to read the quantum state of the qubits.

In some embodiments, processor 1420 can also execute a program code, wherein the qubits are Fluxonium qubits.

It is appreciated that the structure shown in FIG. 14 is only schematic. Computer terminal 1400 may be a terminal device such as a smart phone (such as an Android mobile phone or an iOS mobile phone), a tablet computer, a palmtop computer, a Mobile Internet Device (MID), or a PAD. FIG. 14 does not limit the structure of the electronic apparatus described above. For example, the computer terminal 1400 may further include more or fewer components (such as a network interface and a display apparatus) than those shown in FIG. 14, or has a configuration different from that shown in FIG. 14.

It is appreciated that all or some of the steps of the methods in the embodiments may be implemented by a program instructing relevant hardware of the terminal device. The program may be stored in a computer-readable storage medium. The computer-readable storage medium may include: a flash drive, a Read-Only Memory (ROM), a Random Access Memory (RAM), a magnetic disk, an optical disk, and the like.

The present disclosure further provides a computer-readable storage medium. In some embodiments, the computer-readable storage medium may be configured to store the program code executed by the method for processing the qubits according to some embodiments of the present disclosure.

In some embodiments, the computer-readable storage medium may be located in any computer terminal of a computer terminal group in a computer network, or in any mobile terminal of a mobile terminal group.

In some embodiments, the computer-readable storage medium is configured to store a program code for implementing the following steps: controlling a high excited energy level of qubits to resonate with a target resonant cavity, and the high excited energy level being an energy level greater than or equal to a second excited energy level; and applying microwaves to the qubits in a process of continuous resonance between the high excited energy level of the qubits and the target resonant cavity to control a first excited energy level of the qubits to adiabatically evolve towards a dissipative energy level of the target resonant cavity to initialize the qubits.

In some embodiments, the computer-readable storage medium is configured to store a program code for implementing the following steps: acquiring a first relationship between a frequency of the high excited energy level of the qubits and a magnetic flux applied to the qubits; acquiring a first target frequency of the target resonant cavity; and controlling the high excited energy level of the qubits to resonate with the target resonant cavity by adjusting the magnetic flux applied to the qubits based on the first relationship and the first target frequency.

In some embodiments, the computer-readable storage medium is configured to store a program code for implementing the following steps: acquiring a second relationship between a frequency of the target resonant cavity and a magnetic flux applied to the target resonant cavity; acquiring a second target frequency of the high excited energy level of the qubits; and controlling the high excited energy level of the qubits to resonate with the target resonant cavity by adjusting the magnetic flux applied to the target resonant cavity based on the second relationship and the second target frequency.

In some embodiments, the computer-readable storage medium is configured to store a program code for implementing the following steps: controlling the high excited energy level of the qubits and the target resonant cavity to adiabatically reach a resonance point by adjusting the magnetic flux applied to the qubits or the magnetic flux applied to the target resonant cavity.

In some embodiments, the computer-readable storage medium is configured to store a program code for implementing the following steps: determining target microwaves, and microwave intensity of the target microwaves increasing over time within a predetermined time period; and applying the target microwaves to the qubits in the process of continuous resonance between the high excited energy level of the qubits and the target resonant cavity to control the first excited energy level of the qubits to adiabatically evolve towards the dissipative energy level of the target resonant cavity.

In some embodiments, the computer-readable storage medium is configured to store a program code for implementing the following steps: determining a microwave combination that continuously includes a first microwave band, a second microwave band, a third microwave band, and a fourth microwave band as the target microwaves. An increase rate of the microwave intensity of the first microwave band over time is a first increase rate, the increase rate of the microwave intensity of the second microwave band over time is a second increase rate, and the first increase rate is greater than the second increase rate.

In some embodiments, the computer-readable storage medium is configured to store a program code, wherein the second increase rate approaches zero, the microwave intensity of the third microwave band decreases over time, and the fourth microwave band is in a microwave-free stage.

In some embodiments, the computer-readable storage medium is configured to store a program code, wherein the target resonant cavity is a read resonant cavity coupled to the qubits, and the read resonant cavity is configured to read the quantum state of the qubits.

In some embodiments, the computer-readable storage medium is configured to store a program code, wherein the qubits are Fluxonium qubits.

The embodiments may further be described using the following clauses:

1. A method for processing qubits, comprising:
controlling a high excited energy level of qubits to resonate with a target resonant cavity, the high excited energy level being an energy level greater than or equal to a second excited energy level; and
applying a microwave to the qubits in a process of continuous resonance between the high excited energy level of the qubits and the target resonant cavity to control a first excited energy level of the qubits to adiabatically evolve towards a dissipative energy level of the target resonant cavity to initialize the qubits.

2. The method according to clause 1, wherein controlling the high excited energy level of qubits to resonate with the target resonant cavity comprises:
acquiring a first relationship between a frequency of the high excited energy level of the qubits and a magnetic flux applied to the qubits;
acquiring a first target frequency of the target resonant cavity; and
controlling the high excited energy level of the qubits to resonate with the target resonant cavity by adjusting the magnetic flux applied to the qubits based on the first relationship and the first target frequency.

3. The method according to clause 1, wherein controlling the high excited energy level of qubits to resonate with the target resonant cavity comprises:
acquiring a second relationship between a frequency of the target resonant cavity and a magnetic flux applied to the target resonant cavity;
acquiring a second target frequency of the high excited energy level of the qubits; and
controlling the high excited energy level of the qubits to resonate with the target resonant cavity by adjusting the magnetic flux applied to the target resonant cavity based on the second relationship and the second target frequency.

4. The method according to clause 1, wherein controlling the high excited energy level of qubits to resonate with the target resonant cavity comprises:
controlling the high excited energy level of the qubits and the target resonant cavity to adiabatically reach a resonance point by adjusting a magnetic flux applied to the qubits or a magnetic flux applied to the target resonant cavity.

5. The method according to clause 1, wherein applying microwave to the qubits in the process of continuous resonance between the high excited energy level of the qubits and the target resonant cavity to control the first excited energy level of the qubits to adiabatically evolve towards a dissipative energy level of the target resonant cavity comprises:
determining a target microwave, and microwave intensity of the target microwave increasing over time within a predetermined time period; and
applying the target microwave to the qubits in the process of continuous resonance between the high excited energy level of the qubits and the target resonant cavity to control the first excited energy level of the qubits to adiabatically evolve towards the dissipative energy level of the target resonant cavity.

6. The method according to clause 5, wherein the determining target microwave comprises:
determining a microwave combination that continuously comprises a first microwave band, a second microwave band, a third microwave band, and a fourth microwave band as the target microwave, wherein an increase rate of the microwave intensity of the first microwave band over time is a first increase rate, an increase rate of the microwave intensity of the second microwave band over time is a second increase rate, and the first increase rate is greater than the second increase rate.

7. The method according to clause 6, wherein the second increase rate approaches zero, the microwave intensity of the third microwave band decreases over time, and the fourth microwave band is in a microwave-free stage.

8. The method according to clause 1, wherein the target resonant cavity is a read resonant cavity coupled to the qubits, and the read resonant cavity is configured to read a quantum state of the qubits.

9. The method according to any one of clauses 1-8, wherein the qubits are Fluxonium qubits.

10. A quantum circuit, comprising: a target resonant cavity and qubits, wherein the qubits are coupled to a read line through the target resonant cavity, the target resonant cavity is coupled to the qubits, the qubits are initialized qubits, and initialization of the qubits is achieved by:
controlling a high excited energy level of the qubits to resonate with the target resonant cavity, and the high excited energy level being an energy level greater than or equal to a second excited energy level; and applying a microwave to the qubits in a process of continuous resonance between the high excited energy level of the qubits and the target resonant cavity to control a first excited energy level of the qubits to adiabatically evolve towards a dissipative energy level of the target resonant cavity to initialize the qubits.

11. A quantum chip, comprising: the quantum circuit according to clause 10.

12. A quantum memory, comprising: the quantum circuit according to clause 10.

13. A quantum computer, comprising: a quantum chip and a quantum memory, wherein the quantum chip and/or the quantum memory comprises the quantum circuit according to clause 10.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the disclosure disclosed herein. It is intended that the specification and examples be considered as exemplary only, with a true scope and spirit of the disclosure being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

It should be understood that the disclosed technical content may be implemented in other ways. The apparatus embodiments described above are only schematic. For example, the division of the units is only a logical function division. In actual implementations, there may be another division manner. For example, multiple units or components may be combined or integrated into another system, or some features can be ignored or not implemented. In addition, the displayed or discussed mutual coupling or direct coupling or communication connection may be indirect coupling or communication connection through some interfaces, units, or modules, which may be in electrical or other forms.

The units described as separate components may or may not be physically separated, and the components displayed as units may or may not be physical units, that is, they may be located in one place or may be distributed to a plurality of network units. Part of or all the units may be selected according to actual needs to achieve the purpose of the solution of the present embodiment.

In addition, the functional units in various embodiments of the present disclosure may be integrated into one processing unit, or each unit may exist alone physically, or two or more units may be integrated into one unit. The integrated units described above may be implemented either in the form of hardware or in the form of a software functional unit.

If the integrated units are implemented in the form of a software functional unit and sold or used as an independent product, they may be stored in a quantum computer-readable storage medium. Based on such an understanding, the technical solutions of the present disclosure essentially, or the part making contributions to the prior art, or all or part of the technical solutions may be embodied in the form of a software product. The quantum computer software product is stored in a storage medium and includes several instructions used for causing a quantum computer device to execute all or part of steps of the methods in various embodiments of the present disclosure.

The above are only preferred implementations of the present disclosure. It should be pointed out that, for those of ordinary skill in the art, several improvements and retouches may further be made without departing from the principles of the present disclosure. These improvements and retouches should also be regarded as the scope of protection of the present specification.

In the drawings and specification, there have been disclosed exemplary embodiments. However, many variations and modifications can be made to these embodiments. Accordingly, although specific terms are employed, they are used in a generic and descriptive sense only and not for purposes of limitation.

What is claimed is:

1. A method for processing qubits, comprising:
controlling a high excited energy level of qubits to resonate with a target resonant cavity, the high excited energy level being an energy level greater than or equal to a second excited energy level; and
applying a microwave to the qubits in a process of continuous resonance between the high excited energy level of the qubits and the target resonant cavity to control a first excited energy level of the qubits to adiabatically evolve towards a dissipative energy level of the target resonant cavity to initialize the qubits.

2. The method according to claim 1, wherein controlling the high excited energy level of qubits to resonate with the target resonant cavity comprises:
acquiring a first relationship between a frequency of the high excited energy level of the qubits and a magnetic flux applied to the qubits;
acquiring a first target frequency of the target resonant cavity; and
controlling the high excited energy level of the qubits to resonate with the target resonant cavity by adjusting the magnetic flux applied to the qubits based on the first relationship and the first target frequency.

3. The method according to claim 1, wherein controlling the high excited energy level of qubits to resonate with the target resonant cavity comprises:
acquiring a second relationship between a frequency of the target resonant cavity and a magnetic flux applied to the target resonant cavity;
acquiring a second target frequency of the high excited energy level of the qubits; and
controlling the high excited energy level of the qubits to resonate with the target resonant cavity by adjusting the magnetic flux applied to the target resonant cavity based on the second relationship and the second target frequency.

4. The method according to claim 1, wherein controlling the high excited energy level of qubits to resonate with the target resonant cavity comprises:
controlling the high excited energy level of the qubits and the target resonant cavity to adiabatically reach a resonance point by adjusting a magnetic flux applied to the qubits or a magnetic flux applied to the target resonant cavity.

5. The method according to claim 1, wherein applying microwave to the qubits in the process of continuous resonance between the high excited energy level of the qubits and the target resonant cavity to control the first excited energy level of the qubits to adiabatically evolve towards a dissipative energy level of the target resonant cavity comprises:
determining a target microwave and microwave intensity of the target microwave increasing over time within a predetermined time period; and
applying the target microwave to the qubits in the process of continuous resonance between the high excited energy level of the qubits and the target resonant cavity to control the first excited energy level of the qubits to adiabatically evolve towards the dissipative energy level of the target resonant cavity.

6. The method according to claim 5, wherein determining the target microwave comprises:
determining a microwave combination that continuously comprises a first microwave band, a second microwave band, a third microwave band, and a fourth microwave band as the target microwave, wherein an increase rate of the microwave intensity of the first microwave band over time is a first increase rate, an increase rate of the microwave intensity of the second microwave band over time is a second increase rate, and the first increase rate is greater than the second increase rate.

7. The method according to claim 6, wherein the second increase rate approaches zero, the microwave intensity of the third microwave band decreases over time, and the fourth microwave band is in a microwave-free stage.

8. The method according to claim 1, wherein the target resonant cavity is a read resonant cavity coupled to the qubits, and the read resonant cavity is configured to read a quantum state of the qubits.

9. The method according to claim 1, wherein the qubits are Fluxonium qubits.

10. A quantum circuit, comprising:
a target resonant cavity; and
qubits coupled to the target resonant cavity and coupled to a read line through the target resonant cavity, the qubits being initialized qubits, wherein the qubits are initialized by:
a controlling of a high excited energy level of the qubits to resonate with the target resonant cavity, the high excited energy level being an energy level greater than or equal to a second excited energy level; and
an application of a microwave to the qubits in a process of continuous resonance between the high excited energy level of the qubits and the target resonant cavity of control a first excited energy level of the qubits and the target resonant cavity to control a first excited energy level of the qubits to adiabatically evolve towards a dissipative energy level of the target resonant cavity to initialize the qubits.

11. A non-transitory computer readable medium that stores a set of instructions that is executable by one or more processors of an apparatus to cause the apparatus to perform operations comprising:
controlling a high excited energy level of qubits to resonate with a target resonant cavity, the high excited energy level being an energy level greater than or equal to a second excited energy level; and
applying a microwave to the qubits in a process of continuous resonance between the high excited energy level of the qubits and the target resonant cavity to control a first excited energy level of the qubits to adiabatically evolve towards a dissipative energy level of the target resonant cavity to initialize the qubits.

12. The non-transitory computer readable medium according to claim 11, wherein controlling the high excited energy level of qubits to resonate with the target resonant cavity comprises:
acquiring a first relationship between a frequency of the high excited energy level of the qubits and a magnetic flux applied to the qubits;
acquiring a first target frequency of the target resonant cavity; and
controlling the high excited energy level of the qubits to resonate with the target resonant cavity by adjusting the magnetic flux applied to the qubits based on the first relationship and the first target frequency.

13. The non-transitory computer readable medium according to claim 11, wherein controlling the high excited energy level of qubits to resonate with the target resonant cavity comprises:
acquiring a second relationship between a frequency of the target resonant cavity and a magnetic flux applied to the target resonant cavity;
acquiring a second target frequency of the high excited energy level of the qubits; and
controlling the high excited energy level of the qubits to resonate with the target resonant cavity by adjusting the magnetic flux applied to the target resonant cavity based on the second relationship and the second target frequency.

14. The non-transitory computer readable medium according to claim 11, wherein controlling the high excited energy level of qubits to resonate with the target resonant cavity comprises:
controlling the high excited energy level of the qubits and the target resonant cavity to adiabatically reach a resonance point by adjusting a magnetic flux applied to the qubits or a magnetic flux applied to the target resonant cavity.

15. The non-transitory computer readable medium according to claim 11, wherein applying microwave to the qubits in the process of continuous resonance between the high excited energy level of the qubits and the target resonant cavity to control the first excited energy level of the qubits to adiabatically evolve towards a dissipative energy level of the target resonant cavity comprises:
determining a target microwave, and microwave intensity of the target microwave increasing over time within a predetermined time period; and
applying the target microwave to the qubits in a process of continuous resonance between the high excited energy level of the qubits and the target resonant cavity to control the first excited energy level of the qubits to adiabatically evolve towards the dissipative energy level of the target resonant cavity.

16. The non-transitory computer readable medium according to claim 15, wherein determining the target microwave comprises:
determining a microwave combination that continuously comprises a first microwave band, a second microwave band, a third microwave band, and a fourth microwave band as the target microwave, wherein an increase rate of the microwave intensity of the first microwave band over time is a first increase rate, an increase rate of the microwave intensity of the second microwave band over time is a second increase rate, and the first increase rate is greater than the second increase rate.

17. The non-transitory computer readable medium according to claim 16, wherein the second increase rate approaches zero, the microwave intensity of the third microwave band decreases over time, and the fourth microwave band is in a microwave-free stage.

18. The non-transitory computer readable medium according to claim 11, wherein the target resonant cavity is a read resonant cavity coupled to the qubits, and the read resonant cavity is configured to read a quantum state of the qubits.

19. The non-transitory computer readable medium according to claim 11, wherein the qubits are Fluxonium qubits.
